(19) United States
(12) Patent Application Publication
(10) Pub. No.: US 2025/0006077 A1
(43) Pub. Date: Jan. 2, 2025

(54) AUTO-SCALING, SIMULATED REALITY TASK TRAINING

(71) Applicant: THE WEATHER COMPANY, LLC, Brookhaven, GA (US)

(72) Inventors: Robert N. REDMOND, Smyrna, GA (US); Jennifer M. HATFIELD, Portland, OR (US); Jana H. JENKINS, Raleigh, NC (US)

(21) Appl. No.: 18/342,844

(22) Filed: Jun. 28, 2023

(51) Int. Cl. G09B 19/00; G06F 3/01; G09B 9/00

(52) U.S. Cl. CPC G09B 19/003; G06F 3/011; G09B 9/00

(57) ABSTRACT

Simulated reality task training with auto-scale processing includes initiating a training simulation for a user to complete a task, where the training simulation lacks step-by-step guidance to the user on how to complete the task. The process further includes auto-scaling the training simulation for the user while running, including: generating, based at least in part on user interaction with the training simulation, a plurality of running simulation threads that could arrive as part of the training simulation for the user, and dynamically incorporating a running simulation thread of the plurality of running simulation threads into the training simulation for the user based on the user's interaction with the training simulation. Further, the process includes updating, by the simulated reality system, the plurality of running simulation threads that could arrive as part of the training simulation for the user based on the user's interaction with the training simulation.

### BACKGROUND

This disclosure relates generally to enhancing processing within a computing environment, and more particularly, to simulated reality-based task training.

The virtual training and simulation market continues to grow and expand yearly. Existing training tools are used across industries and verticals from hardware and software to defense, aviation and education. Combined with the growth of simulated reality marketplaces, the demand for augmented training tools is anticipated to continue to expand.

Traditional training materials often rely on a prespecified syllabus with known and defined outcomes to allow for scenario-based learning. Generally, these training experiences are canned and limited by the training platform's possible logical parameters being preset or providing a scoped artificial intelligence-driven decision matrix to represent constrained variety in a training simulation.

An intelligent workflow refers to the orchestration of automation, artificial intelligence, analytics, and skills to change how work gets done, often with a goal of driving efficiency in the completion of activities and management of the underlying workflow through the use of advanced technologies, automation, and data analysis. These activities also provide insights into optimizing the processes involved and potentially those of other workflows.

### SUMMARY

Shortcomings of the prior art are overcome, and additional advantages are provided through the provision of a computer-implemented method. The computer-implemented method includes initiating, by a simulated reality system, a training simulation for a user to complete a task, where the training simulation lacks step-by-step guidance to the user on how to complete the task of the training simulation. In addition, the computer-implemented method includes auto-scaling, by the simulated reality system, the training simulation for the user while running. The auto-scaling includes generating, by the simulated reality system, based at least in part on user interaction with the training simulation, a plurality of running simulation threads that could arrive as part of the training simulation for the user, and dynamically incorporating, by the simulated reality system, a running simulation thread of the plurality of running simulation threads into the training simulation for the user based on the user's interaction with the training simulation. In addition, the auto-scaling includes updating, by the simulated reality system, the plurality of running simulation threads that could arrive as part of the training simulation for the user based on the user's interaction with the training simulation.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with an auto-scaling, simulated reality training module, in accordance with one or more aspects of the present disclosure;

FIG. 3 depicts one embodiment of an auto-scaling, simulated reality training workflow, in accordance with one or more aspects of the present disclosure;

FIG. 4 depicts a further embodiment of an auto-scaling, simulated reality training workflow and system, in accordance with one or more aspects of the present disclosure;

FIG. 5 is a further representation of an auto-scaling, simulated reality training workflow, in accordance with one or more aspects of the present disclosure;

FIG. 6 is an exemplary conceptual diagram of the relation and flow between components of an intelligent system, in accordance with one or more aspects described herein; and

FIG. 7 depicts an example process for AI-based intelligent workflow improvement, in accordance with one or more aspects described herein.

### DETAILED DESCRIPTION

The accompanying figures, which are incorporated in and form a part of this specification, further illustrate the present disclosure and, together with this detailed description, serve to explain aspects of the present disclosure. Note in this regard that descriptions of well-known systems, devices, processing techniques, etc., are omitted so as to not unnecessarily obscure the disclosure in detail. It should be understood, however, that the detailed description and this specific example(s), while indicating aspects of the disclosure, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific systems, code, designs, architectures, protocols, layouts, schematics, or tools only as examples, and not by way of limitation. Furthermore, the illustrative embodiments are described in certain instances using particular software, hardware, tools, systems, or data processing environments only as example for clarity of description. The illustrative embodiments can be used in conjunction with other comparable or similarly purposed structures, systems, applications, or architectures. One or more aspects of an illustrative embodiment can be implemented in software, hardware, or a combination thereof.

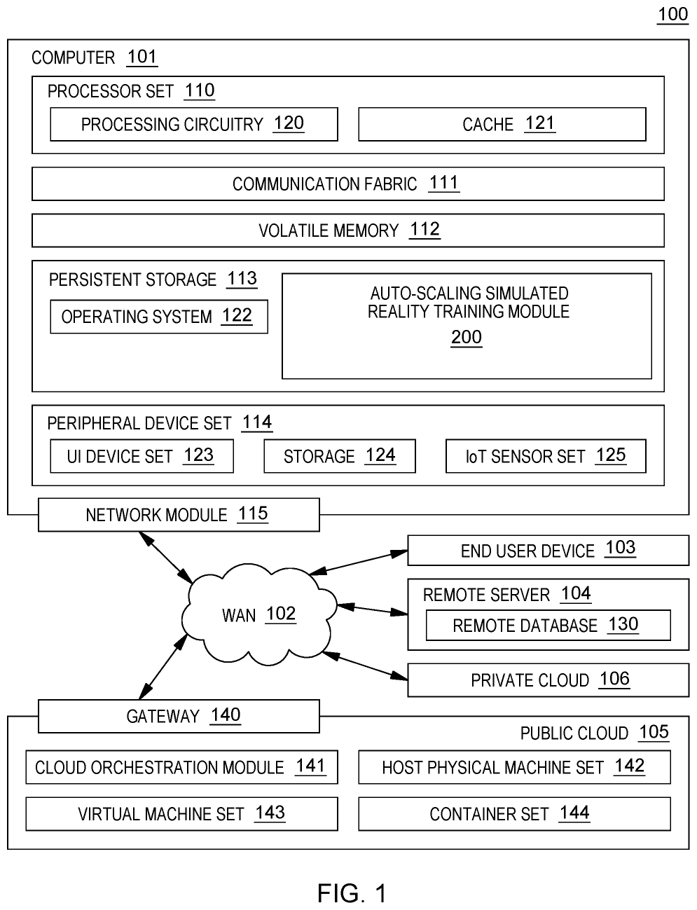

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and auto-scaling, simulated reality training module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform auto-scaling, simulated realty training processing, such as disclosed herein. Aspects of the present disclosure are not limited to a particular architecture or environment.

In one or more aspects, computer-implemented methods, computer systems and computer program products are disclosed herein which provide simulated reality-based task training that is auto-scaling. For instance, in one implementation, supervised, unsupervised, and predictive artificial intelligence models and algorithms are used to automatically generate an expanding training simulation experience for a user. In one implementation, the training simulation can be in a generated universe (of a metaverse) that is auto-constructed for the training experience. In one or more embodiments, the training simulation generation algorithms learn from a corpus of inputs, including, for instance, human-based inputs (e.g., individual actions, texts, imagery, and/or video), and are combined with real-scenario datapoints (e.g., time, space, results, and/or task factors). The combination of these factors in a real-time, simulated reality system scenario (e.g., virtual reality and/or augmented reality scenario) provides the trainee with a next-to-real scenario that adapts (e.g., auto-scales or expands) based on user interaction with the training simulation to, for instance, improve user reaction time and task completion efficiency over repetitive training scenarios. The present disclosure encompasses the intelligent workflow space through simulating, testing, and refining development of scenarios that are enabling processes to occur in a variety of environments, involving both human and digital components.

Generally, intelligent workflows include a set of one or more activities, with each activity including a respective one or more steps. The activity flow refers to the progression through the activity/activities. Each step of each activity is associated with a respective acting entity/actor (such as a person/persona/user), and may be completed in sequence or parallel to other step(s). In one embodiment, each user therefore can have a set of step(s) associated to that user, and that set of step(s) could include step(s) across one or more activities. Progression through the intelligent workflow generally involve progression from one activity to a next by performance of the step(s) in each activity by the involved user(s), and based on successful progression from one step to the next step. In the context of aspects disclosed herein, a user is a person and/or associated user computing device that progresses through one or more steps/activities of the workflow, for instance, in conjunction with other acting entities (in one or more embodiments). Pathways informed by the interactions can indicate success or failure (‘blocking’) depending on whether the interactions are successful or unsuccessful in progressing through the workflow. Such successes and blocks can be identified and indicate a block of the intelligence workflow as a whole—referring to successful completion of the intelligent workflow from start to finish—and/or for individual steps, activities, or collections of steps/activities, as desired.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as auto-scaling, simulated reality training module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

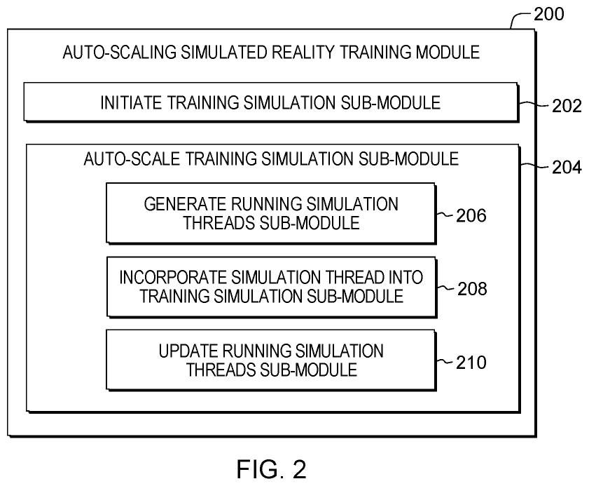

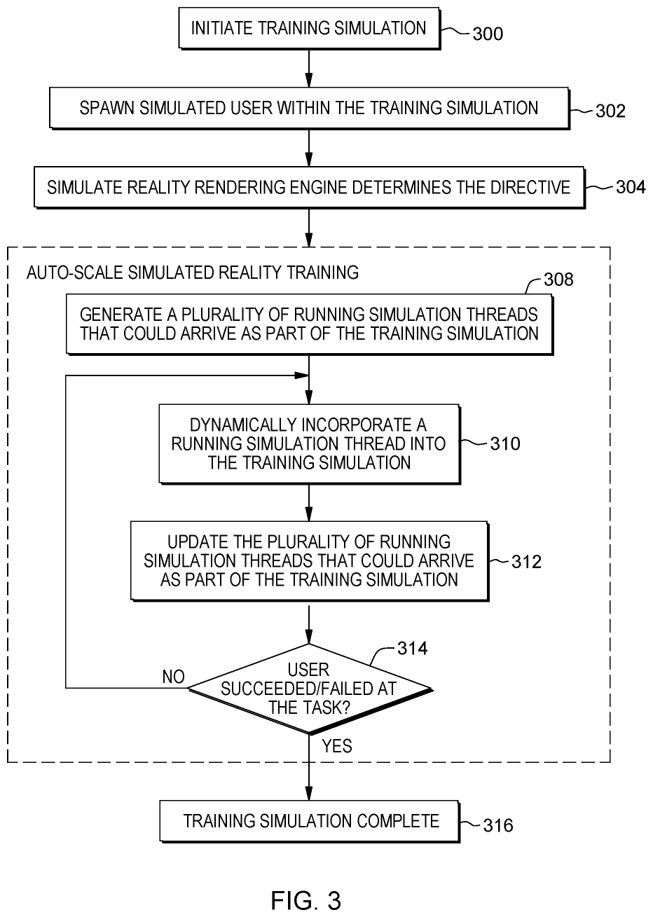

By way of example, one or more embodiments of an auto-scaling, simulated reality training module and workflow are described initially with reference to FIGS. 2-3. FIG. 2 depicts one embodiment of auto-scaling, simulated reality training module 200 that includes code or instructions to perform an auto-scaling, simulated reality training workflow, in accordance with one or more aspects of the present disclosure, and FIG. 3 depicts one embodiment of an auto-scaling, simulated reality training workflow, in accordance with one or more aspects of the present disclosure.

Referring to FIGS. 1 & 2, auto-scaling, simulated reality training module 200 includes, in one example, various sub-modules used to perform processing, in accordance with one or more aspects of the present disclosure. The sub-modules are, e.g., computer-readable program code (e.g., instructions) and computer-readable media (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

In the FIG. 2 embodiment, example sub-modules of auto-scaling, simulated reality training module 200 include, for instance, an initiate training simulation sub-module 202 to initiate, by a simulated reality system, a training simulation for a user to complete a task, where the training simulation lacks guidance to the user on how to complete the task of the training simulation. Further, auto-scaling, simulated reality training module 200 includes an auto-scale training simulation sub-module 204 to auto-scale the training simulation for the user while running. The auto-scale training simulation sub-module 204 includes, in one embodiment, a generate running simulation threads sub-module 206 to generate, by the simulated reality system, based at least in part on user interaction with the training simulation, a plurality of running simulation threads that could arrive as part of the training simulation for the user. Further, the auto-scale training simulation sub-module 204 includes, in one embodiment, an incorporate simulation thread into training sub-module 208 to dynamically incorporate, by the simulated reality system, a running simulation thread of the plurality of running simulation threads into the training simulation for the user based on the user's interaction with the training simulation. In addition, the auto-scale training simulation sub-module 204 includes, in one embodiment, an update running simulation threads sub-module 210 to update, by the simulated reality system, the plurality of running simulation threads that could arrive as part of the training simulation for the user, based on the user's interaction with the training simulation.

Advantageously, auto-scaling, simulated reality training such as disclosed herein automatically generates an expanding training simulation experience for a user to complete a task. The training simulation dynamically adapts and expands based, at least in part, on user interaction with the training simulation, to provide in real-time a next-to-real training simulation scenario that leads to, for instance, improved reaction time and improved task completion over repetitive training scenarios. In one or more aspects, the auto-scaling, simulated reality training process encompasses an intelligent workflow by simulating, testing and refining development of simulated training scenarios that enable processes to occur in a wide variety of environments, such as environments involving both human and digital components.

In one or more embodiments, the sub-modules are used, in accordance with one or more aspects of the present disclosure, to perform auto-scaling, simulated reality training processing. FIG. 3 depicts one example of an auto-scaling, simulated reality training workflow, such as disclosed herein. The method is executed, in one or more examples, by a computer (e.g., computer 101 (FIG. 1)), and/or a processor or processing circuitry (e.g., of processor set 110 of FIG. 1). In one example, code or instructions implementing the method, are part of a module, such as auto-scaling, simulated reality training module 200. In other examples, the code can be included in one or more other modules and/or in one or more sub-modules of the one or more other modules. Various options are available.

As one example, auto-scaling, simulated reality training 300 executing on a computer (e.g., computer 101 of FIG. 1), a processor (e.g., a processor of processor set 110 of FIG. 1), and/or processing circuitry (e.g., processing circuitry of processor set 110), initiates a training simulation for a user to complete a task. The training simulation is a simulated reality training simulation of a simulated reality system that lacks guidance to the user on how to complete the task of the training simulation. Further, the auto-scale simulated reality training process includes spawning for the user a simulated user within the training simulation 302, for instance, at a predefined location with environmental variables. The extent of the training simulation (e.g., universe) can be limited to a predefined circumference around the simulated user. The auto-scaling, simulated reality training process determines, by a simulated reality rendering engine, the directive 304 by employing, for instance, a collection of variables, such as simulated task variables and user-defined variables, to auto-construct a simulated training scenario with known variable states applied.

In one or more embodiments, the auto-scaling, simulated reality training process of FIG. 3 further includes an auto-scale, simulated reality training process 306, which auto-scales (e.g., expands) the training simulation for the user while running. The auto-scaling includes, in one or more implementations, generating, by the simulated reality system, a plurality of running simulation threads that could arrive as part of the training simulation 308. The generating is based (in one embodiment) at least in part on user interaction with the training simulation. In addition, the auto-scaling includes dynamically incorporating a running simulation thread of the plurality of running simulation threads into the training simulation for the user based on the user's interaction with the training simulation 310, and updating the plurality of running simulation threads that could arrive as part of the simulation 312. The updating, by the simulated reality system, is further based, in part, on the user's interaction with the training simulation. The auto-scaling further includes determining whether the user has succeeded or failed at the training simulation task 314. If the user has neither succeeded or failed at the task (e.g., time has expired), the process continues by further dynamically incorporating one or more running simulation threads into the training simulation 310. Once the user as either succeeded for failed at the training simulation task, the current training simulation ends 316.

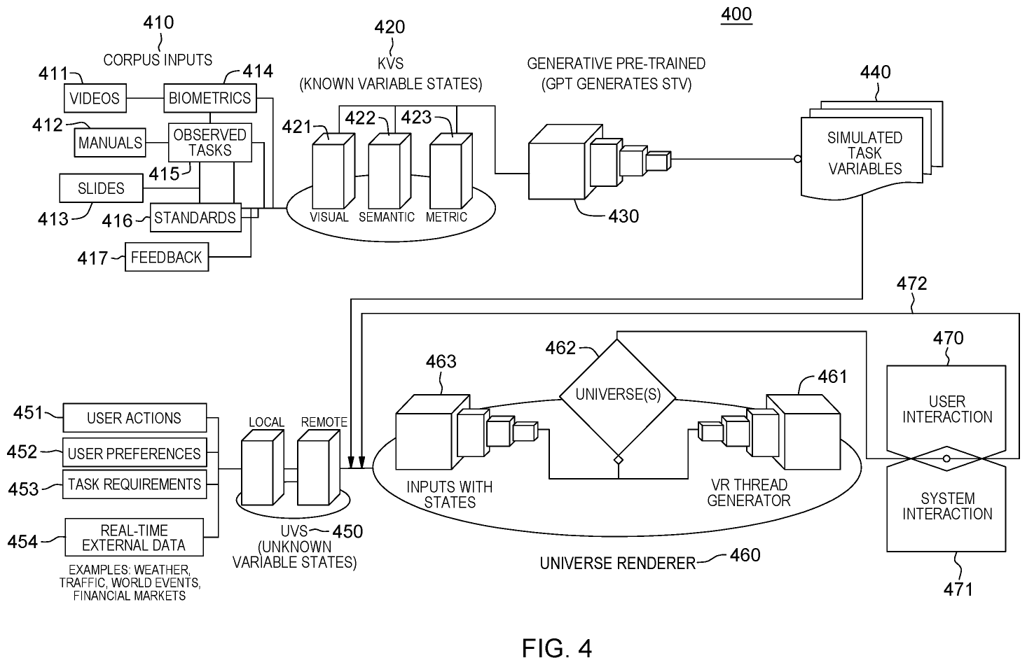

FIG. 4 depicts a further embodiment of an auto-scaling, simulated reality training workflow and system, in accordance with one or more aspects of the present disclosure. Auto-scaling, simulated reality training system 400 includes, or utilizes, in one or more embodiments, a corpus of inputs 410 which can include, for instance, training-related videos 411, manuals 412, slides 413, previously obtained biometrics of users 414 involved with a particular task of the training simulation, observed tasks 415, such as previous completions of the simulated training scenario by one or more individuals, standards for the training tasks 416, as well as feedback 417, such as user feedback and/or director feedback. In one or more embodiments, corpus inputs 410 represent an existing corpus of data content on the training topicality, which as noted, can often include text-based content from documentation and presentations, imagery, and existing videos. In one or more embodiments, an organization can outfit current, pre-trained employees with biometric, motion, and/or video-capturing tools to gather data and visuals from actions performed within real-life scenarios for the task(s) being trained. In one or more embodiments, the collected corpus data and captured data are combined with organizational averages and standards, such as “time to complete task” or “accuracy” to provide training simulation metrics.

The corpus inputs, including captured data, become potential “known variable states (KVS)” 420, and are used to generate a task scenario for a user to experience in real-time within the training simulation (e.g., virtual reality or augmented reality training simulation). In addition to known variable states 420, the auto-scaling, simulated reality training system introduces “unknown variable states (UVS)” 450, which include, for instance, environmental parameters from real-time external data 454, and potential impact trainee choices and actions, such as user actions 451, user preferences 452, which have possible impact within the training session on the environment and circumstances of the training simulation. In addition, task requirements 453 are provided to facilitate directing the variable states. For instance, a trainee in a firehouse simulation not appropriately buttoning their protective jacket, or having to slow the fire truck down due to unforeseen traffic, are examples of user and system interactions that can affect the training simulation. Unknown variable states are influenced by the user's actions, but can also be informed by real-time, external data 454 to help the simulation combine reality with the extended training simulation (e.g., extended universe for training). In a firehouse example, traffic might be defined by actual, observed traffic patterns at a real intersection randomly selected from hundreds of thousands across the world, at the current time of the simulation.

The known variable states 420 are employed by a generative pre-trained (GPT) model 430 to understand and define the “simulated task” or simulated task variables 440 that are to be employed in the simulation. As depicted in FIG. 4, the simulated task variables 440 and the unknown variable states (UVS) 450 are combined as the inputs with states 463 provided to a virtual thread generator 461 of a universe renderer 460, or universe rendering engine, to generate one or more training simulations or universe(s) 462. In one implementation, the virtual thread generator (or rendering engine) 461 employs rules from the known variable states (KVS) 420, simulated task variables 440, and/or generative pre-trained model (GPT) 430, as inspiration to generate the unknown universe states and react constantly, and creatively to stimuli, as described herein.

In accordance with one or more aspects of the present disclosure, the simulated reality of the simulation training scenario is instantiated when the user selects to begin the simulated reality scenario. The simulated reality can be rendered in real-time and a plurality of parallel running simulation threads are generated. For instance, in one or more embodiments, tens, hundreds or even thousands of GPT narrative models are generated and adapted by the universe generator engine informed by real-time interaction with the user, as well as the other inputs.

By way of example, is a sample workflow of system events, processing and generative actions (with reference to the auto-scaling, simulated reality training system 400 of FIG. 4) includes, when a user selects to begin one or more aspects of the disclosure in simulated reality, obtaining a default universe scaling (e.g., via a default universe scaling engine) that employs the simulated task variables 440, processing any predefined user preferences (tool, enabling assets, knowledge depth, historical action in the same domain) and training simulation requirements (locations, key actions, key outcomes, definition of success and/or failure, etc.). System 400 spawns the simulated user in a predefined location within the training simulation with environmental variables. The extent of the training simulation (e.g., universe) is limited to a predefined circumference around the user to begin the simulation. System 400 (e.g., the universe rendering engine or VR thread generator of the system) begins processing both user-provided inputs and situational inputs, and initiates, in one embodiment, the universe renderer 460. Universe renderer 460 determines, in one embodiment, the directive by employing the combined simulated task variables 440 and user-defined variables to auto-construct a simulated training scenario, with known variable states applied.

In one or more embodiments, the user of the training simulation understands the task(s) they are trying to complete within the simulation. However, the simulation system does not deliver a step-by-step guidance to the user to complete the task(s). This limitation in task instruction allows the simulation system to react to the user's inputs and redefine outcomes based on actions the user takes or mistakes made by the user during the specific training simulation scenario. These variances of success or failure in the performance of the task influence the way in which the training simulation scenario evolves. This inherent humanism in the system provides strong inspiration and input for the universe rendering engine 460, which continues running the background, waiting for input to spawn additional running simulation threads.

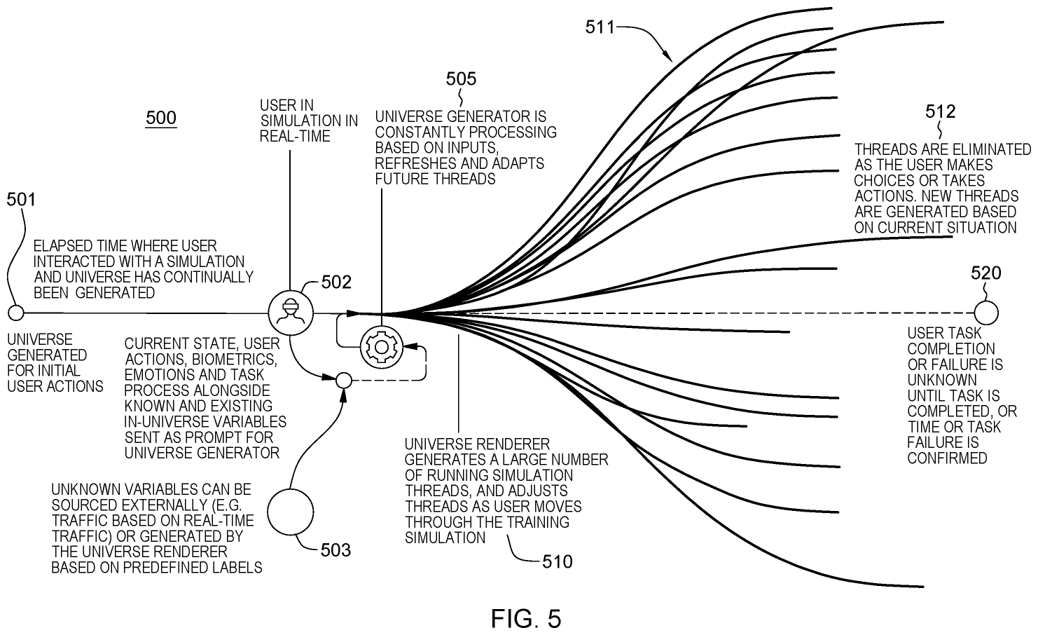

In one or more implementations, system 400 interfaces with or includes sensors that monitor user interaction 470 with the training simulation. For instance, any direction a user moves, action they take, change in state of being, or don't take, and how those choices interact with environmental variables, can inform how the auto-construction builds the training simulation as the simulation scenario progresses. Each action has the potential to instantiate different outcomes, which are rendered in the expanding universe. An example of this is depicted in FIG. 5.

Referring to the expanding universe 500 example of FIG. 5, the universe (i.e., training simulation) was generated for initial user actions 501 and a period of time has elapsed where the user has interacted with the simulation and the universe has continually been generated, resulting in the user 502 being in the simulation in real-time at a certain point of progress. The current state, user actions, biometrics, emotions and task process, as well as known and existing in-universe variables, are sent as prompts for the universe renderer 460 (FIG. 4). In addition, unknown variables can be sourced externally (e.g., traffic based on real-time traffic patterns), or generated by the universe renderer 460 (FIG. 4) based on predefined labels. The VR thread generator is constantly processing data based on inputs, refreshes, and adapts future simulation threads 505, resulting in an evolving set of running simulation threads 511. In one or more embodiments, the universe renderer generates a large number of running simulation threads, as the user moves through the training simulation. For instance, as the user moves through the training simulation, threads can be eliminated as the user makes choices, or takes actions, and new threads can be generated based on the current situation 511. The user task completion or failure is unknown until the task is completed, or time or task failure is confirmed 520. By way of specific example, as illustrated in FIG. 4, the user and system interact 470, 471, with the result 472 being fed back as input to the universe renderer 460 to, in part, facilitate updating of the set of running simulation threads. The ways in which the training simulation can be impacted by user-interaction, or impact the user, include user movement data (for instance, representative task completion, or sudden movements, adverse movements, etc.); biometric feedback data (for instance, heart rate data, perspiration data, balance data, dexterity data, eye movement data of the user during the training simulation); and/or emotional/sentiment feedback data (such as monitored tone data and/or user mood data during the training simulation task effort).

In one or more embodiments, the universe rendering engine 460 runs concurrently while the training simulation is occurring, and the engine receives the user's actions and inputs combined with both known variable states and currently employed unknown variable states. These inputs arrive in the form of a ‘prompt’ to direct or inspire the rendering engine. As one specific example, the rendering engine can be a multi-threaded processing environment, such as one or more clusters of multi-threaded processors, with the computations occurring local or remote from the user's training simulation location. As a specific example, the system can support, for instance, Dall'e (develop by Open AI Incorporated, of San Francisco, California) and/or Midjourney (developed by Midjourney, Inc. of San Francisco, California). In one embodiment, universe rendering engine 460 is continually constructing and incorporating new threads within the universe 462, with outcomes that employ user actions and inputs, and known variable states, while applying new, unknown variable states, to construct possible simulated outcomes based on the user's current progress through the training simulation. By way of example, universe rendering engine 460 can run in real-time and include (or utilize) user inputs, known variables, and current in-simulation unknown variables. In one or more embodiments, the universe rendering engine utilizes generative artificial intelligence. The engine includes processing which labels and flags a structure, and defines outcomes/inputs, and weights user actions against simulated task variables.

As noted, in one or more implementations, the universe rendering engine or universe renderer 460 produces a plurality of parallel running simulation threads 511 (FIG. 5). For instance, in one embodiment, universe renderer 460 (FIG. 4) produces tens, hundreds or thousands of parallel simulation threads that could arrive with the user succeeding in the simulation training task, and tens, hundreds or thousands of simulation threads that could result in the user failing the training simulation task. Each of the simulation models is a thread of virtual reality running concurrently in the background, until (for instance) user action or an additional outside force renders the simulation thread no longer valid. As the user moves through the simulated training task(s), unknown variable states, which are employed by the rendering engine, begin to filter into the process. These variable states can impact the user actions and reactions, and can cause a model for success or failure to have a higher propensity to succeed, in one or more embodiments. As the training simulation progresses, the system determines which training simulation scenarios remain relevant, and which are rendered inapplicable, for instance, by the user interactions with the training simulation. The system continues to generate new parallel running simulation threads (models) based on the possibility of the user arriving at the completion or failure of the task. At the point where the user action diverges from a thread, the thread can be discarded. Additional threads are, in one or more embodiments, being constantly generated until the user has either succeeded in the training task or failed in the training task, based on the known variables, and outcomes defined by the simulated task variables.

Those skilled in the art will note that computer-implemented methods, computer systems and computer program products are provided herein which have an auto-scaling. simulated reality task training facility, in accordance with one or more aspects of the present invention. In one embodiment, a computer-implemented method is provided which includes initiating, by a simulated reality system, a training simulation for a user to complete a task, where the training simulation lacks step-by-step guidance to the user on how to complete the task of the training simulation. In addition, the computer-implemented method includes auto-scaling the training simulation for the user while running. The auto-scaling includes generating, by the simulated reality system, based at least in part on user interaction with the training simulation, a plurality of running simulation threads that could arrive as part of the training simulation for the user, and dynamically incorporating, by the simulated reality system, a running simulation thread of the plurality of running simulation threads into the training simulation for the user based on the user's interaction with the training simulation. In addition, the auto-scaling includes updating, by the simulated reality system, the plurality of running simulation threads that could arrive as part of the training simulation for the user based on the user's interaction with the training simulation.

Additionally, a computer system is provided that includes a memory, and at least one processor in communication with the memory. The computer system is configured to perform a method which includes initiating, by a simulated reality system, a training simulation for a user to complete a task, where the training simulation lacks step-by-step guidance to the user on how to complete the task of the training simulation, and auto-scaling the training simulation for the user while running. The auto-scaling includes generating by the simulated reality system, based at least in part on user interaction with the training simulation, a plurality of running simulation threads that could arrive as part of the training simulation for the user. In addition, the auto-scaling includes dynamically incorporating by the simulated reality system, a running simulation thread of the plurality of running simulation threads into the training simulation for the user based on the user's interaction with the training simulation, and updating, by the simulated reality system, the plurality of running simulation threads that could arrive as part of the training simulation for the user, based on the user's interaction with the training simulation.

Further, a computer program product is provided that includes one or more computer-readable storage media and program instructions collectively stored on the one or more computer-readable storage media readable by at least one processing circuit to initiate a training simulation for a user to complete a task, where the training simulation lacks step-by-step guidance to the user on how to the complete the task of the training simulation, and to auto-scale the training simulation for the user while running. The auto-scaling includes generating, based at least in part on user interaction with the training simulation, a plurality of running simulation threads that could arrive as part of the training simulation for the user; dynamically incorporating by the simulated reality system, a running simulation thread of the plurality of running simulation threads into the training simulation for the user based on the user's interaction with the training simulation; and updating the plurality of running simulation threads that could arrive as part of the training simulation for the user, based on the user's interaction with the training simulation.

In any of the foregoing, and/or alternative, embodiments, the plurality of running simulation threads include a first plurality of running simulation threads that could arrive as part of the training simulation with the user arriving at completion of the task of training simulation, and a plurality of running simulation threads that could arrive as part of the training simulation with the user failing to complete the task of the training simulation.

In any of the foregoing, and/or alternative, embodiments, the updating by the simulated reality system the plurality of running simulation threads includes retaining running simulation threads of the plurality of running simulation threads that remain relevant to the training simulation based on the user's continued interaction with the training simulation, and discarding running simulation threads of the plurality of running simulation threads that are rendered inapplicable for the training simulation based on the user's continued interaction with the training simulation.

In any of the foregoing, and/or alternative, embodiments, the process further includes generating, by a generative pre-trained artificial intelligence model, potential known variable states which define simulated task variables for the simulated reality system to use in the initiating of the training simulation, including processing any predefined user preferences and training simulation requirements.

In any of the foregoing, and/or alternative, embodiments, the initiating includes spawning the user virtually in the training simulation in a predefined location with environmental variables, with extent to the training simulation initiating being limited to a predefined circumference around the virtual user.

In any of the foregoing, and/or alternative, embodiments, the initiating includes auto-constructing by a simulated reality generator of the simulated reality system a virtual reality scenario with no variable states applied, where the simulated related generator auto-constructing the virtual reality scenario determines a directive of a training experience for the user using the simulated task variables and any user-defined variables.

In any of the foregoing, and/or alternative, embodiments, the dynamically incorporating the running simulation thread of the plurality of running simulation threads into the training simulation includes customizing the training simulation to the user based on the user's interaction with the training simulation by redefining training simulation outcomes based on the user interaction with the training simulation.

In any of the foregoing, and/or alternative, embodiments, the user interaction with the training simulation includes interaction data selected from the group consisting of: user movement data obtained during the training simulation, user biometric data obtained during the training simulation, and user sentiment feedback data obtained during the training simulation.

In any of the foregoing, and/or alternative, embodiments, the updating of the plurality if running simulation threads that could arrive as part of the training simulation for the user includes using one or more unknown variable states in updating the plurality of running simulation threads, where the one or more unknown variable states include environmental parameters and real-time external data obtained by the simulated reality system during the training simulation.

As a more specific example, methods, computer systems and computer program products are provided which employ, for instance, supervised, unsupervised and predictive algorithms to automatically generate an expanding training simulation experience (e.g., an expanding metaverse training experience), where the algorithms learn from a corpus of captured data that includes a series of user-crafted inputs (e.g., user actions, texts, imagery and video), and real-scenario datapoints (e.g., time, space, results, and task factors) that combine as potential known variable states, where the potential known variable states are created by a generative, pre-trained (GPT) model to understand and define simulated task variables for the system to employ.

Where the user select to begin the process in a simulated reality, a default universe scaling engine employs the simulated task variables, processing any predefined user preferences (e.g., tools, enabling assets, knowledge depth, historical action in the same domain) and training simulation requirements (e.g., location, task actions, task outcomes, definition of failure). The system spawns the simulated user in a predefined location with environmental variables. The extent of the universe can be limited to a predefined circumference around the user to begin the training simulation.

The rendering engine begins processing both user-provided inputs and situational inputs, and initiates a universe rendering engine (e.g., a generative adversarial network (GAN) rendering engine). The universe renderer determines the directive of a training experience by employing the combined simulated task variables and user-defined variables to auto-construct a training scenario with known variable states applied. The user understands the task they are trying to complete within the simulation. However, the simulation system does not deliver a step-by-step guidance to the user to complete the task. This limitation or instruction allows the system to react to the user's inputs and redefine the outcomes based on the actions the user takes or mistakes the user makes in the training simulation. The variances of success or failure in the performance of a task, influence the way in which the training simulation scenario evolves. This inherent user-based data provides input to the thread generator, which continues running in the background, waiting for data input.

A variety of user data can be employed along with environmental variables to inform how auto-construction builds the simulation threads, and each action has the potential to instantiate different outcomes, which are rendered in the expanding universe of the training simulation. Ways in which the simulation can be impacted, or impact the individual, include, for instance: user movement, task completion, sudden user movement, adverse user movement, etc.; biometric feedback data (such as biometric data on user heartrate, perspiration, balance, dexterity, eye movement, etc.); and/or sentiment feedback (including data obtained from monitoring user tone, mood, etc., during the task effort).

The universe renderer generates, based at least in part on user interaction with the training simulation, a plurality of running simulation threads that could arrive as part of the training simulation for the user. The plurality of running simulation threads are a plurality of concurrent running simulation threads that could arrive as part of the training simulation for the user. For instance, tens, hundreds, or even thousands of simulations, could be generated, with one set of simulations being possible where the user arrives at successfully completing the training task, and the other set is for where the user fails to complete the training task. Each of the models is running concurrently, until a user action or additional outside force renders the model no longer valid.

As the user begins to move through the training simulation task, unknown variable states are filtered into the process. The unknown variable states include, for instance, environmental parameters and potential impacts of user choices and actions on environment and circumstances within the training simulation experience. The unknown variable states can be influence by the user's action, but can also be informed by real-time external data to help the engine combine reality for the extending universe for training. These variables can impact user actions and reactions, and may cause a model for success or failure to have a higher propensity to succeed.

In one or more embodiments, the system determines the scenario models which remain relevant, and those which are rendered inapplicable, with the inapplicable models being discarded, and the relevant models continuing. In addition, the system generates new models based on the possibility of arriving at the completion or failure of the task, such as based on a predicted probability that the user will complete the task successfully, or fail to complete the task successfully.

Those skilled in the art will note that there are multiple potential user-experience implementations using an auto-scaling, simulated reality training module and process such as disclosed herein, depending (for instance) on the type of activity or function the user is training against. In one or more embodiments, a fully-immersive environment is provided in which the user wears a virtual reality headset and utilize virtual reality interaction tools. In this iteration, the entirety of the user's experience can be generated through the virtual reality experience they are viewing. In an alternative scenario, augmented reality glasses (or a device capable of augmented reality projections) can be used, for instance, where the training task may need to be performed in a very specific environment that is difficult to replicate, or for “in the field” training applications. In these scenarios, additional data signals can be gathered, and hence, additional input mechanisms can be used. The mechanisms employed can depend on the specific task being emulated, and the requirements of the task. As an example, a pilot might require specific physical controls that emulate the cockpit. In addition, there can be biometric, audible and external form monitoring to obtain feedback data around the user's interaction with the training simulation and/or state of being (e.g., heart rate, tone and/or body movement). In the scenarios discussed, the rendered universe (i.e., training simulation) utilizes a high memory and fast processing system, such as a multi-threaded computer system/cluster of systems as the computing resources (either local or remote), and an interaction engine which can also run on the processing system (e.g., if the user is tethered to the system), or could run on a separate device (such as a virtual reality or augmented reality apparatus with its own processors and network connections) to the processing system.

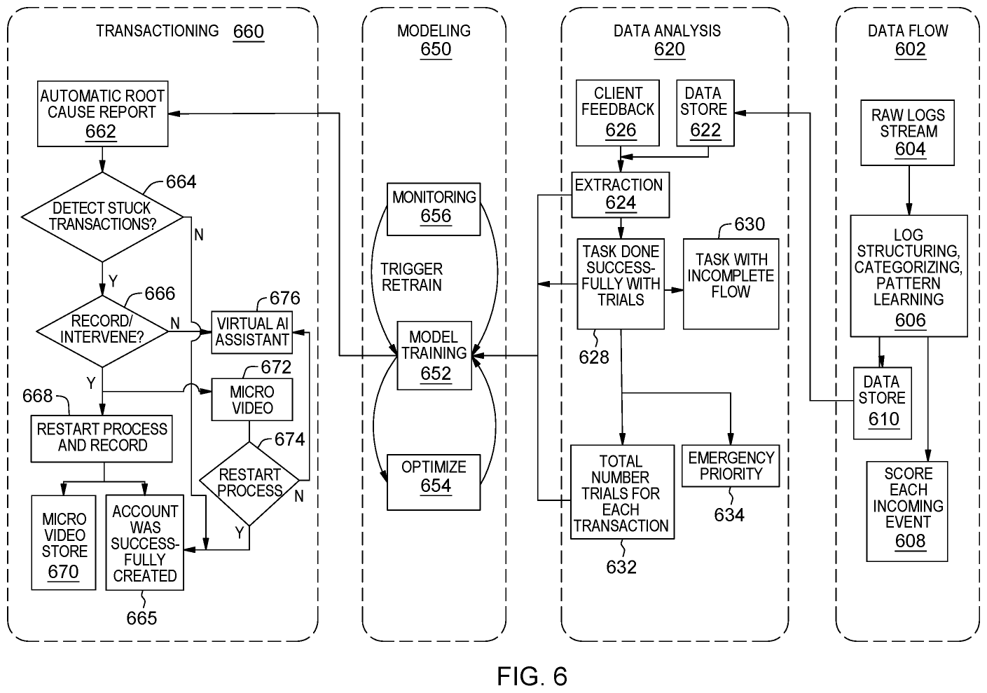

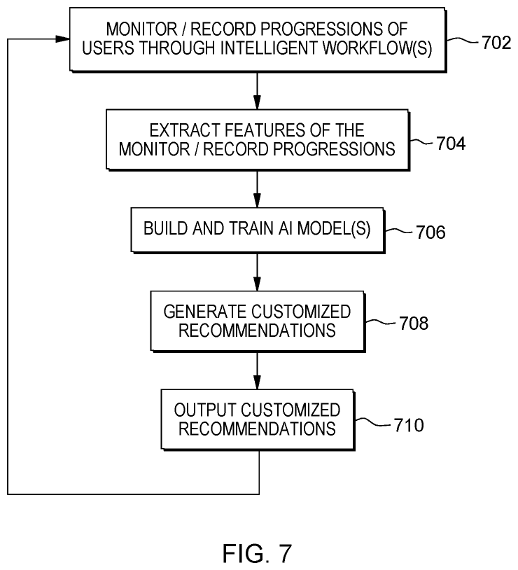

As noted briefly above, in one or more embodiments, the auto-scaling, simulated reality training processing disclosed herein encompasses an intelligent workflow space, which can include simulating, testing and refining development of scenarios that are enabling processes to occur in a variety of training environments and a variety of components. FIGS. 6-7 depict an exemplary conceptual diagram and an example process for artificial-intelligence-based, intelligent workflow processing, one or more aspects of which can be used in accordance with, or to facilitate, the auto-scaling, simulated reality task training disclosed herein. More particularly, in one or more embodiments, the auto-scaling, simulated reality task training process disclosed herein can use, or build upon, various intelligent workflow implementations to, for instance, work with clients and monitor value of a training simulation to a user, while learning and self-adapting the training simulation to correct and improve the overall simulation experience of the user. The process helps to support users by optimizing and adopting new and existing intelligent workflows, including its implementation, to improve, for instance, accessibility and reduce bottlenecks. The task training processing disclosed herein can learn and improve the knowledge and insights at a federated level and generate recommendations and training materials to help support a training simulation scenario implementation, thereby improving accessibility and reducing bottlenecks, with deep insights based on the particular industry and/or task(s) at issue.

FIG. 6 depicts a conceptual diagram of the relation and flow between components of one embodiment of an intelligent system in accordance with one or more aspects described herein. The intelligent system can be implemented/embodied by a combination of hardware and software, for instance, one or more computer systems and one or more modules as described herein.

The system of FIG. 6 includes a data flow component 602 encompassing the capture, recording, or obtaining of raw log streams 604, and log structuring, categorizing, and pattern learning 606 (for instance using unsupervised machine learning) on the raw log streams. The structuring, categorizing, and pattern learning 606 structures the raw log streams into usable and/or harmonized format(s) (as log streams from different systems may be different in terms of their structure/format), categorizes the logged events/actions as desired, and learns patterns exhibited in the logs. Log streams provide logs of any desired event/actions. Logged events might describe interactions, and characteristics thereof, that occur as part of the intelligent workflow, including successful and unsuccessful interactions in terms of progressing a user from one step to another. Logged events could also indicate blockers, timeouts, and other indicators of problems, bottlenecks, challenges, and the like.

Data records other than log streams/events could be produced to log the interactions and characteristics thereof. Recordings of user interfaces (screen recordings) from user devices, voice recordings, helpdesk or other assistant conversations could be recorded and provided to the data flow component 602. Other types of information to analyze and learn from may be recorded.

Incoming events, interactions, results, or characteristics exhibited by the monitored/recorded progressions can be scored (608) on any desired scoring dimension and according to any desired methods, and the data flow component can store its results to a data store 610. Accordingly, the activity of the data flow component (or another component, e.g., monitoring component 656) can provide monitoring and recording of the progressions of users through intelligent workflows to produce stored data records. This includes monitoring/recording during whole or partial sessions/engagement with one or more intelligent workflows. For instance, the monitoring/recording can be performed as a continual process taking place before, during, and after performance of aspects described herein, such as generating and providing customized recommendations for improvement in intelligent workflow(s).

The intelligent system also includes a data analysis component 620 for performing data analysis on the data provided from the data flow component 602. Data analysis component 620 encompasses a database/storage device 622, which could be the data store 610 of data flow component 602 or a different data store. The data analysis component 620 performs data analysis, for instance extraction 624 of features of the monitored/recorded progressions, as reflected by the data from the data store 610 and provided in data store 622. Additionally in this example, client feedback 626 as to user experience and other aspects of the subject intelligent workflow(s) may also be provided in conjunction with the data from data store 622 for analysis and extraction of features of the interactions and progressions of users through the intelligent workflow(s). Extracted features can include any desired features that may be identified from the data analyzed. Example features include detected bottlenecks in progression through an intelligent workflow. Bottlenecks can be determined based on, or informed by, the following, in examples: time taken to progress through aspect(s)—one or more steps, activities, or the entire workflow—of the workflow; cancellations or time-outs in progression through aspect(s) of the workflow; number of trials or attempts to perform actions; speed of successful or unsuccessful interactions; number of interactions to progress through aspect(s) of the workflow; number of steps and/or activities of the workflow; level of expertise needed to progress through the workflow; number, extent, level, and/or duration of assistance provided to user(s) in progressing them through aspect(s) of the workflow; and complexity of aspect(s) of the workflow. These are just some examples of the features that may be extracted to determine/indicate bottlenecks. These markers can be used in conjunction with preconfigured information, such as thresholds, defining what constitutes a bottleneck in terms of any/all of the foregoing. Exceeding threshold(s) for one of more of the markers/metrics could inform that a bottleneck is present, for instance. It is noted that a bottleneck does not necessarily correspond to a blocker, failure, error, or unsuccessful interaction per se; a bottleneck could be taken as something that violates a threshold. For example, an entity for which an intelligent workflow is deployed might define a threshold (e.g., maximum) of 10 seconds to complete for any step of the intelligent workflow. If the average time to complete that step is found to be 14 seconds, though all users are successful in progressing through that step, then this might be considered a bottleneck nonetheless, even though the logs would not necessarily reflect errors or blockers having occurred.

Further, extracted features can include features of successful and/or unsuccessful interactions with the intelligent workflow, and/or could be grouped according to any shared properties, for instance the expertise level of the users, modality of interaction with the intelligent workflow, or other properties.

Feature extraction can be on a per-intelligent workflow basis and/or on an aggregated basis across a collection of intelligent workflows that have been monitored. In the example data analysis component 620 of FIG. 6, the extraction identifies (628) tasks completed successfully with many trials (‘many’ being well-defined by a threshold, function, etc.), as well as tasks with flows not completed (630), and (632) total number of trials for each interaction between the users and the subject intelligent workflow(s). The data analysis component 620 can also extract or identify priorities/priority levels 634 associated with the tasks.

Modeling component 650 of FIG. 6 builds and trains AI model(s) described herein using the extracted features provided by the data analysis component 620. For instance, models(s) to score performance of specific intelligent workflow(s) can be built, though other types of models are possible and discussed herein. In general, a modeling lifecycle of 650 includes model building and training 652 (based on features from data analysis 620 and feedback from transactioning component 660, as examples), optimization 654, and triggered retraining based on monitoring 656 that occurs. Monitoring component 656 refers to the ongoing monitoring discussed above relative to the data flow component. Optimize module 654 refers to the model training/retraining that can occur as frequently as desired.

Modeling 650 provides learning models that can be useful in generating customized, tailored recommendations for improvement in intelligent workflow(s). These recommendations can work in conjunction with, and for implementation by, transactioning component 660 of the intelligent system of FIG. 6. The transaction component 660 has a view to transactions/interactions that either have occurred or are in the process of occurring between users and workflow(s). Based on observed interactions, AI model(s) of the modeling component 650 can be applied to generate recommendation(s) that can then be output. The monitoring. feature extraction, model building/training, generating and outputting of recommendations provides a lifecycle for improvement of existing, deployed intelligent workflows, restructuring of existing intelligent workflows for new applications, industries, modalities, etc., and insights to apply when developing new intelligent workflows.

By way of specific example, transactioning component 660 can operate in the example of FIG. 6 in connection with a customer's interactions with an intelligent workflow to create an account with an online service after visiting the service's website. The transactioning component 660 analyzes a report (662), as one example of an indication of user progression through a workflow, and determines (664) whether a stuck transaction is present. If not (No), the intelligent workflow ends with the account being successfully created (665). Otherwise, a stuck transaction is detected (Yes). At this point, a process, such as a chatbot or other AI-based assistant, asks (666) the user for permission to intervene (and in this case record the interactions between the user and the workflow and/or assistant from that point). The process will continue by restarting (668) progression of the intelligent workflow from some point prior to where the transaction became stuck, for instance from a step that caused the struck transaction or a prior step of the intelligent workflow, and, in this example, store the recording to a video store 670. The video store 670 may be a data source for the data flow component 602 and subsequent data analysis component 620 explained above. In this regard, the user may retry the step and, now based on the system video/screen recording the progression from there as a video of the screen interactions, this provides additional progressions for further analysis (via 620) of a root cause for the stuck transaction.

Meanwhile, in the example of FIG. 6 another action is performed in addition to restarting progression through the intelligent workflow: the process will intervene by, in this example, dynamically presenting/outputting a video 672 to the user device and for the viewer to view. As an example, the video could be a demonstration of a successful transaction/interaction with the intelligent workflow at the point at which the user is stuck. The video could thereby demonstrate for the user how to successfully complete the step on which the user is stuck by presenting a recording of the interactions that another user performed to successful complete the step, for example. By way of specific example, in a situation where a user becomes stuck at a step because the user is to scroll down in the interface to view and click a ‘Submit’ button to progress onward, the video could be a screen recording showing a scroll action to scroll downward in the interface in order to reveal a Submit button for the user to click. The video in this case could be one recorded of another user progressing through the workflow or could be one not recorded from a real interaction scenario—an animation for instance. In some examples. a recorded video is augmented with graphical elements to highlight interface elements, such as input boxes, buttons, sliders, or other interactive interface elements, animations, descriptions, or highlights of actions the user should undertake in interacting with the user's device, or any other augmentations to show the user a successful progression.

A video display for the user constitutes a training action that is output to the user. Other examples training actions include presentation of text communications or initiation of a live chat session (virtual or with a human help agent; text-based, telephone-based, etc.), as examples. More generally, help patterns might exist to assist users in situations where interactions are unsuccessful, a bottleneck is present, or other reasons. Such assistance may be provided even proactively, for instance based on predicting that the user will experience a problem or that some kind of assistance will otherwise be helpful.

Help patterns are one form of customized recommendation for workflow improvement and focus primary on helping users progress through an intelligent workflow. Other types of customized recommendations, for instance suggestions for how to improve aspects of workflow design, implementation, and/or deployment are also possible. Customized recommendations can be learned and provided through the processing of the data flow, analysis, and modeling components of FIG. 6. From monitored interactions, extracted features might show that one particular group of users are significantly more successful than another group of users at a given step. The data analysis component can identify interactions, at that step, that are successful as well as interactions that are not successful, and then group the successful and unsuccessful interactions, for instance. It can then be gleaned by looking at the properties of those groups of interactions that the one group of users is statistically much more likely to successfully progress through the step on their first try, whereas the second group of users is statistically very likely to become stuck at that step. By way of specific example, the first group of users might be users who have location services enabled to their web browser, while the second group has location services disabled, and therefore, the intelligent workflow has trouble with a step that attempts to automatically detect user location. Based on this, a model might determine a help pattern that presents a video or performs some other training action to a user demonstrating how to enable location services and/or how to progress to another step to input the user's location, as an example.

Referring to FIG. 6, the process restarts (e.g., at 668 after beginning recording and/or at 674 either during or after presenting the video 672). In situations where the user is no longer stuck after restart, in one example, the account is created successfully (665). If the user does not want intervention from 666 (No), or if a decision or selection is made not to restart the process after viewing the video (674, No), the process proceeds by directing the user to a virtual AI assistant (676), in this example.

The particular customized recommendations employed by the transactioning component 660, or in the case of a help action the particular action(s) to attempt, may be informed from the modeling component 650 via communication 678 between the two entities, and based on apparent problem(s) experienced. If the problem is an issue with the formatting of user input, a notification, video, or the like presented to a user might inform of the proper format and/or show how to provide the input in the proper format. In general, the help action can be something that an AI model learns and predicts to be successful to address the issue. What is predicted to be helpful can be learned by analyzing monitored interactions of this or other intelligent workflow(s) and extracting features that inform what results in successful (versus unsuccessful) interactions at that given step. As a basic example, the features might indicate that numeric user input, rather than alphabetic characters, are required to progress in the intelligent workflow at the point at which the user becomes stuck. A model might identify this requirement. The same or a different model might identify that this particular user is likely to experience a blocker at this step due to improper input. The same or a different model might identify an action to take, either proactively before the user hits the blocker or in response to the user hitting the blocker, for instance an action to show or otherwise indicate to the user that the input is to be numeric and not alphabetic characters.

Accordingly, aspects described herein can generate customized training materials to help support intelligent workflow implementation, improve accessibility, and reduce bottlenecks, as examples. In a specific example, a process analyzes and divides/groups interactions of one or more intelligent workflows (for instance all intelligent workflows for completing a task) and distributes the interactions into one of three disjoint classes: (i) interactions that were successful in progressing the user through the given intelligent workflow, (ii) interactions that did not involve engagement between the user and an AI assistant and that resulted in abandonment of the task progression through the intelligent workflow, and (iii) interactions that did involve engagement between the user and an AI assistant but that resulted in abandonment of the task progression through the intelligent workflow. A fourth class, one that groups together interactions that involved a support ticket on the specific intelligent workflow, could also be used. Then, for each of the aforementioned classes and/or on an aggregate basis across users in the classes, the feature extraction can extract/record the following features (as examples):
time spent per activity, referring to some amount of time (total for a given sample, average or median across samples, etc.) to progress through an activity;
demographics, referring to one or more demographics of users having the subject interactions;
number of trials on the given step, referring to total attempts made to progress through the given step;
average speed of successful progression through step(s);
number of instances of missing information in an information field;
number of interactions user(s) have with an AI assistant, such as a total number across all of the aforementioned classes;
instances of natural language processing used against interaction responses with an AI assistant;
instances of natural language processing used against support ticket(s) associated with intelligent workflow(s);
number of trials on the intelligent workflow, referring to a number of attempts for users to progress through the intelligent workflow;
level of digital expertise of the users and/or familiarity of the users with a deploying entity;
modality, referring to the engagement channel (e.g., mobile, web, kiosk, voice, etc.) through which the user engages with the intelligent workflow;
number of AI assistant interactions taken, per step, referring to a reflection of the degree of help needed to help progress user(s);
number of total steps in the intelligent workflow(s);
number of total activities in the intelligent workflow(s); and/or
complexity of the intelligent workflow.

The above can be considered on a singular basis (per user, per session, per intelligent workflow, etc.) and/or on an aggregated basis (across users of a given intelligent workflow, across users who attempted a given step, across workflows that incorporate the same/similar step, etc.).

With the features collected, one or more AI models can be built. One such model is a model that is trained to identify a specific intelligent workflow from among a collection of available intelligent workflows, for instance to distinguish between intelligent workflows. Such a model may be trained on the various steps of the flows, types of input values provided at each step, and expected output at each step, with distinctions made between at least successful and unsuccessful progressions between consecutive steps. Another example AI model is a customer classifier model that is trained to help an AI assistant determine, in real time as a user interacts with an intelligent workflow and from the observed interactions, an amount of help the user actually or is expected to need, and potential blocker points of the intelligent workflow. This model may be or incorporate, for instance, a neutral network trained to identify an expertise level of the user. A second, multiclass, AI model (e.g., as a neural network) can be built and trained to identify and rank potential bottleneck steps, and this could be done for each of the expertise levels. The bottlenecks to expert users may be expected to differ from bottlenecks to beginners. Aspects can learn, from the monitoring and feature extraction, the expertise levels of users, and this can be for users of a single entity (since customer of the intelligent workflow provider) and/or across users of a collection of entities. An additional example AI model is a support ranking model that is trained to rank severity of support/helpdesk incidents into a collection of classes, for instance high severity, medium severity, and low severity. The model can also be trained to open an incident/ticket in the background for any intelligent workflow that was found to be abandoned by a user where the user has not opened an incident/ticket. As yet another example AI model, a scenario simulation model could be generated that combines the above-noted models and is parametrized to generate data and associated combination of steps, interactions, and events to simulate low, medium, or high severity incidents. In a particular example, a generative model based on generative adversarial network(s), deep learning, and/or machine learning could be used depending on the complexity of the generation.

Additional aspects provide for learning and improvement in knowledge and insights gained at a federated level, and generation of recommendations and training materials to help support intelligent workflow implementation, improve accessibility, and reduce bottlenecks, with deep insights per industry, intelligent workflow type, user demographic, modality/channel of user engagement, and any of various other properties and characteristics about which features may be extracted based on monitoring intelligent workflow progressions and interactions. Aspects can authenticate and monitor usage from various channels, such as mobile, web, kiosk, etc., can assess the impact of removing a set of activities/steps from existing deployments of intelligent workflows, identify gaps, detect optimum modality (the best experience for a user to consume a specific workflow) for effective engagement, and shift or emphasize modalities accordingly.

The features and associated learnings garnered from monitoring and analyzing interactions of one particular deployed intelligent flow for one particular entity can be federated on multiple dimensions. One such dimension is among similar entities implementing the same intelligent workflow under similar user demographics. Federated insights extracted using AI models as described herein can be correlated to other entities within and without that industry in order to build a model that classifies the intelligent workflow's digital fitness and potential for accuracy and alignment with that other entity and/or the industry in which that entity sits. Furthermore, adjustments in modality, training, and education that showed adoption improvements can be leveraged by other entities as well at the industry level. Another dimension is within the same client departments as within the same industry, where intelligent workflows can share common events and steps, such as a first intelligent workflow that shares a user information and user profile related step with a second intelligent workflow. If the first intelligent workflow encounters issues in digitization and the models above classify it as high complexity with a low adoption profile and many support issues with specific steps, this insight may be useful in improving the second intelligent workflow. For instance, the insight can be federated to an intelligent workflow digitization, as an AI model trained to identify a specific intelligent workflow among a collection of available intelligent workflows can classify the two intelligent workflows (first and second above) as similar and identify problematic steps, for instance potential blocker steps and events, in the second intelligent workflow if it was proposed to be used elsewhere. An analysis insight might recommend a customization of that second intelligent workflow, for instance, or the modality experience to use in order to avoid some of the problems observed with the first intelligent workflow.

Improvement in intelligent workflows has technical effects of increasing efficiency in data and digital communication between computer systems engaging in and/or hosting processing of the workflow steps and activities. Improvements provide reduced session durations, retry attempts, repeated communications, and the like, and improve processing, which in turn reduces processing power and resources needed in executing the intelligent workflows. Additional improvements are provided in the form of optimized automated training systems, and smarter and more effective AI assistants and chatbots. Additionally, optimized and more efficient intelligent workflows improve entity digital presence by reaching to more users and new markets, improve user satisfaction by improving user experience.

FIG. 7 depicts an example process for AI-based intelligent workflow improvement, which can be used in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 7 are part of a module. In other examples, the code may be included in one or more modules and/or in one or more sub-modules of the one or more modules. Various options are available.

The process of FIG. 7 includes monitoring and recording (702) progressions of users through an intelligent workflow. The intelligent workflow includes computerized activities through which the user progresses through interactions with the intelligent workflow via, for instance, graphical user interfaces. The recording of these progressions can produce stored data records that reflect the interactions and properties thereof. In embodiments, the recording includes producing, as at least some of the stored data records: logs, screen recordings, voice recordings, and/or helpdesk conversations.

The process continues by extracting (704) features of the monitored and recorded progressions as reflected by the stored data records. The extracting can include analysis of the interactions for use in gaining insights therefrom. The extracted features could include detected bottlenecks to progression through the intelligent workflow. For instance, the detected bottlenecks could include: time to complete one or more computerized activities of the plurality of computerized activities; time to complete one or more steps of the intelligent workflow; number of steps of the intelligent workflow; number of activities of the intelligent workflow; number of trials on a step of the intelligent workflow; number of trials of the intelligent workflow; number of interactions with an AI-based assistant; and/or rate of termination in progressing through the intelligent workflow, as examples.

The process builds and trains (706) at least one artificial intelligence (AI) model using the extracted features. In embodiments, a built and trained AI model can be configured to classify, based on interactions of a user, an expertise level of the user, and identify a ranking of potential bottlenecks to the user in progressing through the intelligent workflow. In embodiments, a built and trained AI model is configured to classify instances of unsuccessful progression through the intelligent workflow by severity.

The process of FIG. 7 also generates (708), using the at least one AI model, customized recommendations for improvement of the intelligent workflow. The customized recommendations could include a training action for presentation to a user progressing though the intelligent workflow. The customized recommendations could additionally or alternatively include a recommended modality for users to consume the intelligent workflow in order to optimize their engagement with the intelligent workflow. The customized recommendations could additionally or alternatively include a recommendation to modify a step of the intelligent workflow, and/or a recommendation to supplement a step of the intelligent workflow with the training action. An example of such a supplement is to show a video or other demonstration to a user to help the user successfully progress through a step/activity of the intelligent workflow.

In embodiments, the process can also use the at least one AI model to generate customized recommendations for improvement in one or more existing intelligent workflows and/or the design of one or more intelligent workflows to be developed and deployed.

Based on generating the customized recommendations, the process proceeds by outputting (710) the customized recommendations. The outputting includes dynamically presenting the training action to the user on a graphical user interface through which the user interacts with the intelligent workflow as part of progressing through the intelligent workflow. In embodiments, the training action can include provision of a video, a text communication, and/or a chat session.

In an embodiment, the extracted features include features of successful interactions with the intelligent workflow. In a further embodiment, the building and training (706) the at least one AI model trains an AI model, using the features of successful interactions, to generate the training action to be presented based on detecting a bottleneck of the detected bottlenecks. In yet a further embodiment, the outputting (710) includes dynamically presenting the training action to the user based on actual or predicted presence of the bottleneck in the user progressing through the intelligent workflow. In one or more embodiments, an AI model learns, based on the training using the features of the successful interactions, how the bottleneck may be avoided.

In one or more embodiments, the process also groups the interactions based on user type, for instance an expertise level, a web modality used, or any other one or more properties, and/or an industry for which the intelligent workflow is deployed. In one or more embodiments, the generating (708) produces customized recommendations that vary across different user types, and/or different industries. As an example, a model can learn to classify expertise of a set of users and, for each learned expertise class, the most likely bottleneck(s) for users in that class.

In one or more embodiments, the process iterates over a length of time. For instance, the process can repeat, for each additional intelligent workflow of a plurality of additional intelligent workflows, the monitoring and recording progressions, and the extracting features, to produce additional sets of extracted features. In one or more embodiments, the building and training of the at least one AI model can use the additional sets of extracted features, and thus recommendations can be generated based on the model(s) build based on monitoring across intelligent workflows. In one or more embodiments, the monitoring and recording can monitor results of having generated and output the customized recommendations. This feedback can inform how successful the recommendations have been, if implemented. For example, the monitoring and recording can monitor results of having dynamically presented the training action to the user. The results providing feedback as to whether the training action is helpful in progressing though the intelligent workflow. This can be used in further training of model(s).

The terminology used herein is for the purpose of describing particular embodiments only and is not intended to be limiting of the disclosure. As used herein, the singular forms “a”, “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
initiating, by a simulated reality system, a training simulation for a user to complete a task, the training simulation lacking step-by-step guidance to the user on how to complete the task of the training simulation; and
auto-scaling, by the simulated reality system, the training simulation for the user while running, the auto-scaling comprising:
generating, by the simulated reality system, based at least in part on user interaction with the training simulation, a plurality of running simulation threads that could arrive as part of the training simulation for the user;
dynamically incorporating, by the simulated reality system, a running simulation thread of the plurality of running simulation threads into the training simulation for the user based on the user's interaction with the training simulation; and
updating, by the simulated reality system, the plurality of running simulation threads that could arrive as part of the training simulation for the user, based on the user's interaction with the training simulation.

2. The computer-implemented method of claim 1, wherein the plurality of running simulation threads include a first plurality of running simulation threads that could arrive as part of the training simulation with the user successfully arriving at completion of the task of the training simulation, and a second plurality of running simulation threads that could arrive as part of the training simulation with the user failing to complete the task of the training simulation.

3. The computer-implemented method of claim 1, wherein the updating the plurality of running simulation threads comprises retaining running simulation threads of the plurality of running simulation threads that remain relevant to the training simulation based on the user's continued interaction with the training simulation and discarding running simulation threads of the plurality of running simulation threads that are rendered inapplicable for the training simulation based on the user's continued interaction with the training simulation.

4. The computer-implemented method of claim 1, further comprising generating, by a generative pre-trained artificial intelligence model, potential known variable states which define simulated task variables for the simulated reality system to use in the initiating of the training simulation, including processing any predefined user preferences and training simulation requirements.

5. The computer-implemented method of claim 4, wherein the initiating comprises spawning the user virtually in the training simulation in a predefined location with environmental variables, with extent of the training simulation initiating being limited to a predefined circumference around the virtual user.

6. The computer-implemented method of claim 5, wherein the initiating comprises auto-constructing, by a simulated reality generator of the simulated reality system, a virtual reality scenario with known variable states applied, the simulated reality generator auto-constructing the virtual reality scenario including determining a directive of a training experience for the user using the simulated task variables and any user-defined variables.

7. The computer-implemented method of claim 6, wherein the dynamically incorporating the running simulation thread of the plurality of running simulation threads into the training simulation includes customizing the training simulation to the user based on the user's interaction with the training simulation by redefining training simulation outcomes based on the user interaction with the training simulation.

8. The computer-implemented method of claim 1, wherein the user interaction with the training simulation includes interaction data including one or more of: user movement data obtaining during the training simulation, user biometric data obtained during the training simulation, and user sentiment feedback data obtaining during the training simulation.

9. The computer-implemented method of claim 1, wherein the updating of the plurality of running simulation threads that could arrive as part of the training simulation for the user includes using one or more unknown variable states in updating the plurality of running simulation threads, the one or more unknown variable states including environmental parameters and real-time external data obtained by the simulated reality system during the training simulation.

10. A computer system comprising:
a memory; and
at least one processor in communication with the memory, wherein the computer system is configured to perform a method, said method comprising:
initiating, by a simulated reality system, a training simulation for a user to complete a task, the training simulation lacking step-by-step guidance to the user on how to complete the task of the training simulation; and
auto-scaling, by the simulated reality system, the training simulation for the user while running, the auto-scaling comprising:
generating, by the simulated reality system, based at least in part on user interaction with the training simulation, a plurality of running simulation threads that could arrive as part of the training simulation for the user;
dynamically incorporating, by the simulated reality system, a running simulation thread of the plurality of running simulation threads into the training simulation for the user based on the user's interaction with the training simulation; and
updating, by the simulated reality system, the plurality of running simulation threads that could arrive as part of the training simulation for the user, based on the user's interaction with the training simulation.

11. The computer system of claim 10, wherein the plurality of running simulation threads include a first plurality of running simulation threads that could arrive as part of the training simulation with the user successfully arriving at completion of the task of the training simulation, and a second plurality of running simulation threads that could arrive as part of the training simulation with the user failing to complete the task of the training simulation.

12. The computer system of claim 10, wherein the updating the plurality of running simulation threads comprises retaining running simulation threads of the plurality of running simulation threads that remain relevant to the training simulation based on the user's continued interaction with the training simulation and discarding running simulation threads of the plurality of running simulation threads that are rendered inapplicable for the training simulation based on the user's continued interaction with the training simulation.

13. The computer system of claim 10, further comprising generating, by a generative pre-trained artificial intelligence model, potential known variable states which define simulated task variables for the simulated reality system to use in the initiating of the training simulation, including processing any predefined user preferences and training simulation requirements.

14. The computer system of claim 13, wherein the initiating comprises spawning the user virtually in the training simulation in a predefined location with environmental variables, with extent of the training simulation initiating being limited to a predefined circumference around the virtual user.

15. The computer system of claim 14, wherein the initiating comprises auto-constructing, by a simulated reality generator of the simulated reality system, a virtual reality scenario with known variable states applied, the simulated reality generator auto-constructing the virtual reality scenario including determining a directive of a training experience for the user using the simulated task variables and any user-defined variables.

16. The computer system of claim 15, wherein the dynamically incorporating the running simulation thread of the plurality of running simulation threads into the training simulation includes customizing the training simulation to the user based on the user's interaction with the training simulation by redefining training simulation outcomes based on the user interaction with the training simulation.

17. The computer system of claim 10, wherein the user interaction with the training simulation includes interaction data including one or more of: user movement data obtaining during the training simulation, user biometric data obtained during the training simulation, and user sentiment feedback data obtaining during the training simulation.

18. The computer system of claim 10, wherein the updating of the plurality of running simulation threads that could arrive as part of the training simulation for the user includes using one or more unknown variable states in updating the plurality of running simulation threads, the one or more unknown variable states including environmental parameters and real-time external data obtained by the simulated reality system during the training simulation.

19. A computer program product comprising:
one or more computer readable storage media and program instructions collectively stored on the one or more computer readable storage media readable by at least one processing circuit to:
initiate a training simulation for a user to complete a task, the training simulation lacking step-by-step guidance to the user on how to complete the task of the training simulation; and
auto-scale the training simulation for the user while running, the auto-scaling comprising:
generating, based at least in part on user interaction with the training simulation, a plurality of running simulation threads that could arrive as part of the training simulation for the user;
dynamically incorporating by the simulated reality system, a running simulation thread of the plurality of running simulation threads into the training simulation for the user based on the user's interaction with the training simulation; and
updating the plurality of running simulation threads that could arrive as part of the training simulation for the user, based on the user's interaction with the training simulation.

20. The computer program product of claim 19, wherein the program instructions readable by the at least one processing circuit to update the plurality of running simulation threads are further readable by the at least one processing circuit to retain running simulation threads of the plurality of running simulation threads that remain relevant for the training simulation based on the user's continued interaction with the training simulation, and discard running simulation threads of the plurality of running simulation threads that are rendered inapplicable for the training simulation based on the user's continued interaction with the training simulation.
